(19) United States
(12) Patent Application Publication
(10) Pub. No.: US 2002/0167898 A1
(43) Pub. Date: Nov. 14, 2002

(54) Restoration of IP networks using precalculated restoration routing tables

(76) Inventors: Phi Cam Thang, Winnipeg (CA); Jose Alejandro Rueda, Winnipeg (CA); Attanhiru Sule Alfa, LaSalle (CA)

Correspondence Address: ADE & COMPANY, 1700-360 MAIN STREET, WINNIPEG, MB, R3C3Z3, CA

(21) Appl. No.: 10/073,059

(22) Filed: Feb. 12, 2002

Related U.S. Application Data
(60) Provisional application No. 60/268,080, filed on Feb. 13, 2001.

(51) Int. Cl. G01R 31/08; G06F 11/00; G08C 15/00

(52) U.S. Cl. 370/216; 370/400

(57) ABSTRACT

Fast restoration of an IP network in the event of a link failure is achieved, in advance of the conventional recalculation scheme which remains as a second phase of restoration, by pre-calculating for the network a minimum number of spanning trees arranged to provide alternative paths in the event that communication between two routers is determined to have failed, by providing routing tables based upon the spanning trees and by switching to the new routing tables when a link failure is detected using high speed detection at the physical layer to avoid delay. An algorithm is provided to calculate the spanning trees which are kept to a low number of two or three which is practical for storage in the memory of the routers.

This invention relates to a method of restoring an IP network in the event of a communication failure between two routers which uses precalculated and stored restoration routing tables.

### BACKGROUND OF THE INVENTION

The increase in demand for faster and more reliable networks has placed a heavy burden upon network and protocol designers. The issue of restorability is not new. It has been around for many years. It is now, as the number of Internet users and demands for higher data rates climb exponentially, that this issue is more prevalent. This document introduces a restoration method for the network layer. A two-phase restoration scheme is proposed where pre-configured routing tables are used to provide for fast restoration. An optimization model is proposed as a solution to determining the optimal set of pre-configured routing tables necessary. The steps needed for implementation in an OSPF environment using MPLS and Active Networking are briefly described.

In the networks of today and the future, network survivability is, and will still be, an area of great concern to all users. The need for more reliable and robust networks is even more apparent as the number of Internet users continues to climb at an exponential rate.

With transmission rates in the order of Gigabits per second (0bps), the need for reliable data transfer is critical. At such speeds, large corporations, small businesses, and even the average household Internet user can potentially lose large amounts of revenue with just a minor disruption in their communications network.

It would be incorrect to assume that current networks are not survivable, this is indeed far from the truth. There are many methods and techniques already in place that handle failures within the network. The problem is that efficient restoration techniques reside at the Physical Layer. There are some techniques at the network layer where restoration is handled by routing protocols. Internet routing protocols were designed for survivability and even though they address restorability, they take sometimes up to several minutes. Physical layer techniques provided by SONET [10] (Synchronous Optical Network) provide fast restoration within the tens of milliseconds. However, Physical Layer faults are often catastrophic faults that do not encompass faults at the Network Layer. With the growing support for IP (Internet Protocol) and its capability to enhance communication services, IP networks require stability and reliability. This leads to a need for restoration methods provided by the routing protocols that run at the IP Network Layer.

RIP (Routing Information Protocol) [1] uses a 30 second interval between routing table broadcasts. In the event of a failure within the RIP network where a routing table update is not received, RIP will wait 6 times the update interval (180 seconds) before declaring the routing table entry unreachable. OSPF (Open Shortest Path First) [2], on the other hand has a much better restoration scheme in place. With a typical hello interval (equivalent to RIPs update interval) of 10 seconds, OSPF waits for 4 times the hello interval before recalculating routes. This 40 second interval is far better than the 3 minutes that RIP requires, but at gigabit rates, tremendous amounts of information can still be lost. In the case of Transmission Control Protocol/Internet Protocol (TCP/IP) this could cause an excessive amount of retransmissions and lead to congestion due to the nature of the TCP protocol.

Since Physical Layer faults do not encompass Network Layer faults and restoration using the routing protocols is slow due to the mechanisms that are used, a new approach is needed in handling IF faults at the Network Layer. Restoration at the Network Layer can help to alleviate some of the problems associated with the two existing methods.

Restoration is a term typically associated with Physical Layer protection mechanisms. In most of the available literature to date, restoration appears in the context of survivable ATM (Asynchronous Transfer Mode) or SONET networks.

Network Layer restoration is a new area of research of very high interest, due to the rapid growth in demand for IP networks. There are several differences in the problem formulations for restoration at the Physical Layer, or even at layer 2 of the OSI (Open Systems Interconnection) Reference model (for example the ATM layer), and restoration at the Network Layer. One of the main differences is that restoration at the Network Layer might be temporary (not necessarily in response to a failure in the transport system). Failures at this layer are not restricted to open links or high bit error rates (BER), but also to congestion, system downtime, reconfiguration, rebooting of a router, addition of resources, etc. Restoration at the Network Layer refers to fast recovery and convergence to a new optimal state. Restoration must be dynamic, that is, there is not necessarily a unique optimal state. The optimal state can vary and can be recalculated as required.

In this section, a survey of available literature, both recent and classic, are studied for restoration techniques and applications. The reader is encouraged to review these publications and references therein. A common theme in the references discussed below is that they consider restoration of failures in high-speed networks which are near catastrophic. This type of failure is typically due to failures in the communications equipment. A failure in a relatively small amount of time can lead to very high data losses.

One of the most important contributions to restoration at the Physical Layer is the self-healing ring concept [3]. In that paper Grover, presented a study of the restoration problem in telecommunications networks and proposed a mechanism for decentralized restoration. This decentralized mechanism was intended to aid and complement centralized protection systems. The paper discussed problems related to restoration due to loss of all or most of the physical transmission facilities between two nodes. Grover pointed out that restoration via rerouting through redundant connections should not be confused with individual call rerouting. The self-healing ring concept has been widely accepted and it has been applied in the industry.

A study of restoration schemes for survivable ATM networks was presented by Murakami and Kim [4]. They also proposed a methodology for end-to-end restoration through a comparative analysis of the minimum link capacity installation cost. The methodology is an optimal capacity and flow assignment algorithm for the self-healing of ATM networks based on end-to-end and line restoration. One of their main results is that the economic advantage of the end-to-end restoration method might be marginal for a well-connected and/or unbalanced network. In the solution of the linear programming problem they presented an elegant approach by solving and utilizing the dual problem for recalculation of the solution. Murakami and Kim also proposed a two-step scheme for fast restoration. In their method, an accelerated recovery procedure is executed upon the knowledge of a failure. After recovery procedures are complete, a new optimal solution is calculated for the entire network.

Hsing, Cheng, Goncu and Kant [5] presented a restoration methodology based on pre-planned routing for ATM networks. The idea is based on communication of neighbouring nodes with the sources to find an alternate route. This methodology of having routes calculated prior to any faults occurring is very beneficial in terms of speed. Once a failure occurs, all that is necessary is for the nodes to do a lookup on the pre-planned routes, which is faster than performing calculations as faults occur.

Finn et. al. [6] and Medard et. al. [7] introduced a new approach for protection switching using trees. In their approach each node in the network will find two directed spanning trees, one to be used for normal conditions and one for failed conditions. With assumptions that the network be vertex or edge redundant, the algorithm is restricted to certain network topologies. Their method can be viewed as a generalization of some techniques used in SONET, such as Automatic Protection Switching and Self-Healing Rings.

Grover and Stamatelakis [8], [9] have developed a restoration scheme using pre-configured cycles (p-Cycles). This methodology is similar to SONET rings yet use spare capacity much more efficiently for restoration. The p-Cycles restoration scheme for physical and IP networks were discussed with focus being placed on the SONET physical layer. These papers also give a comparison of p-Cycles and SONET rings.

This section the variables, signals and alarms that are potentially important to the topic of network restoration.

The following is a list of important variables and parameters in configuring OSPF for Network Layer restoration:

Cost: The cost of sending a packet on an interface.

Metric: The metric used for generating the default route.

Hello Protocol: The Hello Protocol is used for establishing and maintaining neighbour relationships. It also makes sure that there is bidirectional communication between the neighbours.

HelloInterval: The interval, specified in seconds, of time that hello packets that a router sends on the interface.

RouterDeadinterval: The interval, specified in seconds, of time that hello packets must not have been seen before neighbouring routers will declare the router down,

Inactivity Timer: A single shot timer such that when fired indicates that a hello packet has not been seen from this neighbour recently. The timer value is the RouterDeadInterval time.

spf Timers: The delay time between when OSPF receives a change in topology and when it starts to calculate the shortest path. You can also configure the hold time between two consecutive spf calculations.

LSAge Field: The amount of time in seconds that have elapsed since the LSA was first originated.

LLDown: A signal to indicate that the Logical Link has lost connection.

The following is a list of SONET signals and alarms for restoration:

Section Signals

LOS: Loss of Signal

LOF: Loss of Frame

S-BIP: Section-level Bit-interleaved Parity error

Line-level Signals

L-AIS: Line-level Alarm Indication Signal

L-RDI: Line-level Remote Detection Indication

L-BIP: Line-level Bit-interleaved Parity error

L-FEBE: Line-level Far End Block Error

Path-level Signals

P-AIS: Path-level Alarm Indication Signal

P-RDI: Path-level Remote Detection Indication

P-BIP: Path-level Bit-interleaved Parity error

P-FEBE: Path-level Far End Block Error

LCD: Loss of Cell Delineation

Other Path Errors

TIM: Trace Identifier Mismatch

SLM: Signal Label Mismatch

UNEQ: Unequipped Signal

All of the above three signals will cause a P-RDI to be returned

The following References disclose subject matter which may be relevant to the present invention, the disclosure of which is incorporated herein by reference:

[1] G. Malkin, RFC 2458: RIP Version 2, November, 1998.

[2] J. Moy, RFC 2828: OSPF Version 2, April, 1998.

[3] W. D. Grover, The Self healing Network: A Fast Distributed Restoration Technique for Networks using Digital Crossconnect Machines, Proc. IEEE Globecom, 1987.

[4] K. Murakami and H. S. Kim, Comparative Study on Restoration Schemes of Survivable ATM Networks, Proc. IEEE Infocom, April, 1997.

[5] D. K. Hsing, B. Cheng, G. Goncu, and L. Kant, A Restoration Methodology based on Pre-Planned Source Routing in ATM Networks, Proc. IEEE Int. Conference on Communications, 1997.

[6] S. C. Finn, M. M. Menard, and R. A. Barry, A Novel Approach to Automatic Protection Switching Using Trees, Proc. IEEE hit. Conference on Communications, 1997.

[7] M. M. Medard, S. C. Finn, R. A. Barry, and R. C. Gallager, Redundant Trees for Preplanned Recovery in Arbitrary Vertex-Redundant or Edge-Redundant Graphs, IEEE/ACM Transactions on Networking, Vol. 7, No. 5, October, 1999.

[8] D. Stamatelakis, W. D. Grover, Rapid Span or Node Restoration in IF Networks Using Virtual Protection Cycles, Proc. CCBR'99, 1999.

[9] W. D. Grover, D. Stamatelalds, Cycle-Oriented Distributed Preconfiguration: Ring-like Speed with Mesh-like Capacity for Self-planning Network Restoration, Proc. CCBR'98, 1998.

[10] W. 3. Goralski, SONET: A Guide to Synchronous Optical Networks, McGraw-Hill Companies, New York, 1997.

[11] W. L. Winston, OPERATIONS RESEARCH: Applications and Algorithms, Duxbury Press, Belmont, Calif., 1994.

[12] P. Barth, OPBD—A Davis-Putnam Based Enumeration Algorithm for Linear Pseudo-Boolean Optimization, http://www.mpi-sb.mpg.de/units/ag2/software/opbdp/.

[13] P. Barth, A Davis-Putnam Based Enumeration Algorithm for Linear Pseudo-Boolean Optimization, Max-Planck-Institut für Informatik, Germany, 1995.

[14] 5. Agrawal, A Framework for Multiprotocol Label Switching, Internet Draft, November, 1997.

[15] D. Alexander, et al., The SwitchWare Active Network Implementation, University of Pennsylvania, September 1998.

[16] The Janos Project, Java-oriented Active Network Operating System, website: http://www.cs.utah.edu/flux/janos/.

[17] OSKit++, website: http://www.cs.utah.edu/flux/oskit/.

[18] D. Alexander et al., Active Network Encapsulation Protocol(ANEF), Active Networks Group, RFC Draft, July, 1997.

[19] D. S. Alexander, W. A. Arbaugh, A. D. Keromytis, J. M. Smith, Security in Active Networks, Bell Labs, Lucent Technologies, Distributed Systems Lab, 1999.

[20] J. Moy, RFC 2828: OSPF Version 2, April, 1998.

[21] S. Armstrong, A. Freier, K. Marzullo, RFC 1801: Multicast Transport Protocol, February, 1992.

[22] R. Braudes, S. Zahele, RFC 1458: Requirements for Multicast Protocols, May, 1993.

[23] J. Moy, RFC 1584: Multicast Extensions to OSPF, March, 1994.

[24] D. Eppstein, Of/line Algorithms for Dynamic Minimum Spanning Tree Problems, Tech. Report 92-04. Dept. of Info. and Comp. Sci., University of California, Irvine, Calif., 1992.

### SUMMARY OF THE INVENTION

It is one object of the present invention therefore to provide an improved method of restoring an IP network which allows restoration to occur substantially without delay.

The failures with which the invention is concerned are referred to hereinafter as communication faults which can be caused by the failure of a link (or arc) between two routers (or nodes) or can be caused by a partial or complete failure of one of the nodes. In practice, the other node at the end of a link will detect a failure in the communication without necessarily being able to determine what has occurred in the link or at the other node to cause the failure.

According to the invention therefore there is provided a method of restoring an IP network in the event of a communication failure between two routers comprising:

providing an IP network comprising:

a plurality of routers;

a plurality of links between the routers for communication of data between each router and any other one of the routers, the links being arranged to provide between each router and each of the other routers at least two alternative paths;

the network being arranged such that each router is provided with a respective primary routing table by which there is provided for that router a respective one of a plurality of preferred paths selected from the alternative paths from that router to each of the other routers;

communicating the data between the routers using for routing the data the primary routing tables;

before a communication failure occurs, pre-calculating for the network a plurality of spanning trees arranged to provide alternative paths in the event that communication between two routers is determined to have failed;

for each of the calculated spanning trees, providing for each the routers a respective one of a plurality of restoration routing tables and storing in a memory associated with each router the plurality of restoration routing tables for that router in preparation for a communication failure;

detecting a fault indicative of a communication failure;

depending upon the two routers between which the communication is determined to have failed, selecting one of the spanning trees and the restoration routing tables associated with that spanning tree;

communicating to the routers an instruction to transfer routing from the primary routing table to the selected one of the pre-calculated restoration routing tables stored in the memory of the router;

and communicating the data between the routers using the selected, pre-calculated, stored restoration routing tables.

It is a primary feature of the invention that the routing is transferred to the restoration tables substantially without delay, that is with any delay being significantly shorter than the conventional delays used in conventional schemes which can be as short as 40 seconds or as much as 3 minutes, so that the amount of data lost is significantly reduced from the conventional schemes.

The number of spanning trees which can be available needs in a practical implementation to be relatively small so that the number of restoration tables to be held in memory is at a practical level. Thus in practice there likely will be only two or three spanning trees with a corresponding number of restoration tables for partially or fully meshed networks.

Preferably the spanning trees are pre-calculated to minimize number of spanning trees necessary to restore all paths or to restore a maximum number of paths since in some arrangements of the network it may not be possible to restore all paths. However in a practical arrangement the number may not be the actual minimum provided it is kept to a practically acceptable small number.

In a particularly preferred arrangement, the spanning trees are pre-calculated by the algorithm specified in the specification, although other algorithms are possible and will be available to one skilled in this art.

In one operation scheme, when a communication failure is detected by a router, that detection of a communication failure causes a communication to all other routers to use the restoration table.

In an alternative operation scheme, when a communication failure is detected by a router, that detection of a communication failure causes a communication only to edge routers and wherein the edge routers are arranged to modify the communicated data to communicate the requirement to use the restoration tables to internal routers.

In one operation scheme the communicated data is modified by adding a tag.

In another operation scheme the communicated data is modified by changing the information contained in the ANEP header.

In accordance with a particularly preferred and important feature, the restoration tables form a first fault response system and there is provided a secondary conventional fault response system. Thus the present scheme can be grafted onto existing restoration schemes in which, after a pre-determined delay after detection of a fault without the communication being restored, the primary router tables are recalculated taking into account the absence of the failed communication and the routers arranged to transfer routing back to the re-calculated primary routing tables, which are normally calculated by the routers to provide an optimum scheme and thus take considerable time to calculate.

In order to provide rapid response, the fault detection preferably does not rely upon the conventional absence of a hello packet but instead uses other conventional flags conventionally available such as those generated in response to a detection in the physical layer so as to be substantially without delay. These flags may be less reliable and thus are not conventionally used or conventional schemes in view of the complexity of those schemes.

One important aspect of this invention is the realization that the number of spanning trees for a practical network can be calculated, for example using the algorithm set out hereinafter, to proved a relatively low number which is small enough to allow the restoration tables to be practically managed and stored in an effective implementation.

### BRIEF DESCRIPTION OF THE DRAWINGS

FIG. 1 shows how the two-phase restoration system works.

FIG. 2 illustrates a screenshot of the spanning tree generator software STG with two spanning trees generated.

FIG. 3 shows a six node network example connected in various configurations to illustrate certain scenarios.

FIG. 4 depicts the routing changes for a short lived failure. The resume notification would cause the primary scheme to be deactivated. This would disable MPLS(do not attach labels) or active networking(do not encapsulate) so that routing of data is resumed by OSPF.

FIG. 5 shows the routing changes for a persistent failure. Since OSPF recognizes a fault after the RouterDeadInterval time, the node which issued the fault notification would also listen on the failed interface for the same amount of time. If no Hello packet is seen, then the node would issue a resume notification to the ingress and egress nodes to terminate the primary scheme.

### BRIEF DESCRIPTION OF THE TABLES

Table 1 gives a comparison between these network topologies.

### DETAILED DESCRIPTION

Both RIP and OSPF have suitable restoration mechanisms in place. It is not necessary to replace these mechanisms. Instead, these mechanisms should be enhanced or adapted to provide better performance. The method proposed here is to have a two-phase restoration scheme. The first phase is to use a proposed restorable spanning tree algorithm when a failure is first detected. The second phase is to use the default restoration mechanisms provided by the routing protocols. The combination of the restoration mechanisms provides for a more robust and survivable network. Our approach will use OSPF as the protocol for study.

Two Phase Restoration

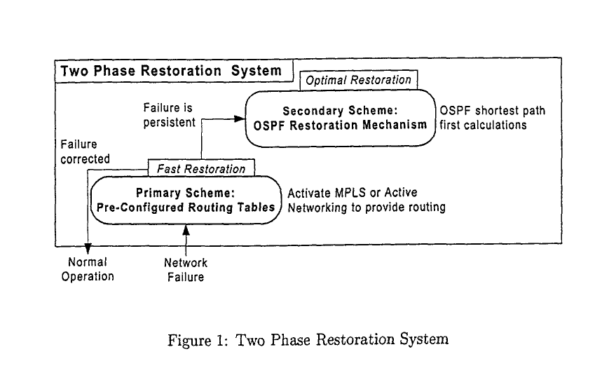

Our approach is to design a supervisory system which will monitor and control the underlying routing protocol. This system will be responsible for detecting faults within the network and taking appropriate action to handle the fault. Our approach focused in on the restoration mechanisms after a fault has been detected. FIG. 1 shows how the two-phase restoration system works.

When a network failure is detected by some other means, the primary scheme is activated providing fast restoration to the network. If the network failure is short lived (less than the RouterDeadInterval Time), the primary scheme is deactivated. This returns OSPF to it's original state before the network failure. However, for more persistent failures, the secondary scheme is activated. This scheme is the OSPF restoration mechanism which will calculate an optimal shortest path for the network. The following section will give more details as to what takes place in the primary scheme.

Multiple Routing Tables

Our approach is to have routers within the network maintain preconfigured restoration tables. In the event of failure, for example carrier loss detection or a missed Hello packet, we propose a mechanism to switch between the original routing table to the restoration table. The preconfigured restoration tables and mechanism used to switch between tables together form the primary scheme for the two-phase restoration system. The secondary scheme would be OSPF's original restoration mechanism which occurs after the RouterDeadInterval time.

Two possible alternatives to handle the switching from the original routing table to the restoration table are discussed in our approach. These two possibilities are Multi-Protocol Label Switching (MPLS) and Active Networking. With both of these, the restoration table will be used to route packets in the event of a failure. Since this table is independent of the original OSPF routing table, there is no change of the OSPF routing table. Packets will continue to be rerouted using these MPLS or active networking routes until OSPF recalculates its routes to adjust for the link failure after the specified RouterDeadInterval time. Integration of our approach, MPLS and active networking with OSPF will be discussed in the following section.

Two main benefits can be seen with our approach over that of OSPF. The first and most important is that restoration time is greatly reduced as compared to OSPF having to wait a predefined RouterDeadInterval time before responding. With the primary scheme in place, communication can be re-established quickly by activating MPLS or active networking using the restoration table. The second benefit of reducing the number of spf (shortest path first) calculations, stems from the fact that precalculated restoration tables are used. By using these tables, the original OSPF routing table is not modified. Since the original OSPF routing table is unaffected by the primary scheme, if there was a short period of failure (less than RouterDeadInterval), no spf calculations would have to take place because OSPF did not recognize that there was a fault in the network. The primary scheme would have handled all communications within the network during that time. MPLS or active networking would be deactivated once the failure is corrected and OSPF can continue normal routing operations. The problem is determining how many additional routing tables there need to be, and the table entries.

Multiple Spanning Trees

Let us recall what the entries in a routing table represent. Typically entries represent the next hop along the shortest path from the source to the destination. This is not the case for all routing protocols, but it is with regards to OSPF. By looking at the network as a whole, each individual routing table will contribute a small part to the overall routing topology.

That is to say, a complete path from source to destination can be determined by looking at the entries in all the routing tables. Completing the path for each source to destination pair using the routing tables will form a set of paths that are interconnected in some fashion. The only condition that needs to be satisfied is that the interconnection of the paths do not form cycles, as defined in the sense of graph theory. So, in essence, routing tables for a network form a connected acyclic graph which is better known as a tree. This however is not specific enough since a tree may not connect all the nodes in the graph. For the routing topology to be usable, all the nodes must be in the tree, or in other words, the tree must span the entire network. This is commonly referred to as a spanning tree.

A definition of a spanning tree of a network is a subnetwork that contains all the nodes but only enough links (N−1 links, where N is the number of nodes in the graph) to form a tree. It is noted that a spanning tree of a network can potentially be used as a restoration path for any of the links not contained in the spanning tree. To further clarify, since there exists a path from each node to every other node in the network across the spanning tree, the failure of any of the links not contained in the spanning tree would not affect data flow through the network. Therefore we can conclude that the links not contained in the spanning tree are restorable.

Now consider a set of spanning trees that span the network. If there exists a spanning tree that does not contain a link (i, j), for all links, then the network is considered fully restorable. It will be assumed that all failures are considered to be link failures affecting both arcs between the adjacent nodes. It is quite trivial to find a set of spanning trees that meet the above condition, but we want to minimize the number of spanning trees while still providing maximum restorability. By choosing spanning trees to be as disjoint as possible, we are in effect restoring more links with fewer spanning trees. This can be done by minimizing the number of times a link appears in the set of spanning trees. The effect of this would be to load balance or spread out the spanning trees across the network in terms of the number of times a link is being used in the spanning tree set. Doing so would minimize the number of spanning trees that are needed because links that have not been restored yet will be chosen first in the creation of the next spanning tree.

Formal Problem Definition

The model developed in our approach is based on several assumptions. These assumptions are not too restrictive, but are reasonable. The following assumptions are made:

A set of nodes is given for the network.

A set of arcs which specify the interconnection of the nodes is given.

A traffic matrix specifying traffic between all nodes is given.

The number of routing tables to create is known.

All failures are considered to be links failures.

The network is modeled as a graph G=(N, A), where N is a set constituting the nodes in the graph and A is the set of directed arcs which specify connectivity of the nodes in N. Let us define the difference between an arc and a link. A link (i, j) represents a bidirectional connection between nodes i and j which is composed of two directed arcs, (i, j) and (j, i). To maximize restoration, it is sufficient to minimize the number of times a link appears in the spanning tree set. Let us first define some variables that are to be used in the formulation:

T represents the number of spanning trees to create with t being the t^{th} spanning tree in the set of spanning trees.

The pair (i, j) represent a link (i, j) composed of two directed arcs from A.

o and d represent the origin and destination of a path. Let wᵢⱼ^{t} be the elements of W representing whether or not an arc is being used in the set of spanning trees, where

$${w}_{ij}^{t} = \{ \begin{matrix}1 , & if {\sum }_{o ∈ N} {\sum }_{d ∈ N} {x}_{ij}^{tod} > 0 ; \\ 0 , & otherwise .\end{matrix}$$

with xᵢⱼ^{tod} defined as the following:

$${x}_{ij}^{tod} = \{ \begin{matrix}1 , & \text{if link (} \text{i} \text{,} \text{j} \text{) is used in a route table} \text{t} \\ & \text{and is along the path for the} \text{od} \text{pair} ; \\ 0 , & \text{otherwise} .\end{matrix}$$

The objective of the algorithm is to find the xᵢⱼ^{tod} elements which will lead us in determining the wᵢⱼ^{t} components of the W. This is of course taking into consideration the capacity constraints cᵢⱼ of the network as well as the flow constraints fᵢⱼ^{t}.

The problem can now be stated as follows.

Problem P

$$d = {\sum }_{i , j ∈ A} {( {\sum }_{t} {w}_{ij}^{t} )}^{2} \qquad ( 1 )$$

Minimize

subject to

$${\sum }_{j ∈ N} {x}_{ij}^{tod} - {\sum }_{k ∈ N} {x}_{ki}^{tod} = {b}^{tod} ( i ) , ∀ o ∈ N , ∀ d ∈ N , ∀ i ∈ N , ∀ t ∈ T \qquad ( 2 )$$

fᵢⱼ^{t}≦cᵢⱼ, ∀i, j ∈A, ∀t ∈ T (3)

$${\sum }_{∀ i , j ∈ A} {w}_{ij}^{t} \leq 2 * ( \vert N \vert - 1 ) , ∀ t ∈ T \qquad ( 4 )$$

wᵢⱼ^{t}−1≦yᵢⱼ^{t}, ∀i, j ∈ A, ∀t ∈ T (5)

1−wᵢⱼ^{t}≦yᵢⱼ^{t}, ∀i, j ∈ A, ∀t ∈ T (6)

$$\begin{matrix}{\sum }_{o ∈ N} {\sum }_{d ∈ N} {x}_{ij}^{tod} \leq M ( 1 - {y}_{ij}^{t} ) , ∀ i , j ∈ A , ∀ t ∈ T & ( 7 ) \\ {w}_{ij}^{t} \leq {\sum }_{o ∈ N} {\sum }_{d ∈ N} {x}_{ij}^{tod} , ∀ i , j ∈ A , ∀ t ∈ T & ( 8 )\end{matrix}$$

wᵢⱼ^{t}=wᵢⱼ^{t}, ∀i, j ∈ A, ∀t ∈ T (9)

$${f}_{ij}^{t} = {\sum }_{o ∈ N} {\sum }_{d ∈ N} {x}_{ij}^{tod} {e}^{od} , ∀ i , j ∈ A , ∀ t ∈ T \qquad ( 10 )$$

wᵢⱼ^{t} ∈ 0,1, ∀i, j ∈ A, ∀t ∈ T (11)

xᵢⱼ^{tod} ∈ 0,1, ∀o ∈ N, ∀d ∈ N, ∀i, j ∈ A, ∀t ∈ T (12)

yᵢⱼ^{t} ∈ 0,1, ∀i, j ∈ A, ∀t ∈ T (13)

cᵢⱼ,fᵢⱼ^{t},e^{od},t≧0 ∀o ∈ N, ∀d ∈ N, ∀i, j ∈ A, ∀t ∈ T (14)

In this formulation, Constraint 2 is the connectivity constraint. It states that each node along the path for an od pair, has a value equal to 0 if it is an intermediate node, 1 if the node is the origin and −1 if the node is the destination. In other words:

$${b}^{tod} ( i ) = \{ \begin{matrix}1 , & if i = o ; \\ - 1 , & if i = d ; \\ 0 , & \text{otherwise.}\end{matrix}$$

This connectivity constraint also satisfies the flow conservation law by guaranteeing that all nodes must be connected in some fashion. This does not imply that the actual capacity demand of the flow is being satisfied, but merely ensures that there is a path for each od pair. Ensuring that the capacity demands of the flows are being satisfied is governed by Constraint 3.

Constraint 3 represents the capacity constraint of the network. The element cᵢⱼ is the total available capacity of arc (i, j) and fᵢⱼ^{t} is the total amount of traffic flowing through arc (i, j) for routing table t. In this formulation, a unit of capacity can represent a T1 link or an OC-3 link depending on the network. For example, if all connections in a network used T1 links, then an arc (i, j) with capacity 3, can be represented by 3 separate arcs of unit capacity spanning nodes i and j. It is necessary to note that although a single arc can be represented by many smaller links, it does not mean that there are physically more arcs spanning two nodes. The representation is merely to provide an abstraction in dealing with the capacity constraint.

Assuming that traffic flows between all nodes, Constraint 4 combined with Constraint 2 guarantee that the network will be configured in a spanning tree. If the network was not a spanning tree, then the connectivity constraint will be violated and consequently, a routing table can not be generated from a network topology that contains cycles.

Constraints 5 through 8 define the relation between the decision variables xᵢⱼ^{tod} and wᵢⱼ^{t}. The definition of wᵢⱼ^{t} can be restated as the following non-linearity:

$${w}_{ij}^{t} = 1 - {\prod }_{o , d} ( 1 - {x}_{ij}^{tod} ) , ∀ i , j ∈ A , ∀ t ∈ T . \qquad ( 15 )$$

This is very similar to an If-Then constraint [11] in integer programming, where if one constraint is satisfied, then the other constraint must be satisfied. Using this approach, definition 15 can be restated as Constraints 5 through 8, where y ∈ 0, 1 and M is equal to the number of possible origin destination pairs.

M≦|N|·|N−1|.

Looking at Constraint 7, for the left-hand side of the constraint to be positive (an arc (i, j) is being used by an od pair), yᵢⱼ^{t} must be equal to 0. This leads to the conclusion that wᵢⱼ^{t}=1 from Constraints 5 and 6, that is

wᵢⱼ^{t}−1≦0 [symbol] wᵢⱼ^{t}≦1

1−wᵢⱼ^{t}≧0 [symbol] wᵢⱼ^{t}≧1

If the left-hand side of Constraint 7 is 0 (arc (i, j) is not being used by any od pair), then the value of yᵢⱼ^{t} must be 1. This leads to the following two equations from Constraints 5 and 6:

wᵢⱼ^{t}≦2

wᵢⱼ^{t}≦0

From these two equations, wᵢⱼ^{t} is less than or equal to zero. To force equality, Constraint 8 is used. These four constraints (5 to 8) change the nonlinear constraint 15 to a set of linear constraints.

For the flow variable fᵢⱼ^{t}, it can be defined as stated in Constraint 10, where e_{od} is specified by the traffic matrix E. The traffic matrix is a square n×n (where n=|N|) matrix, with each element representing the average amount of traffic flowing from node i to node j.

There is one question left unanswered, and that is with regards to the value of T. T represents the number of routing tables that are needed. If the value of T is chosen to be too small (less than the minimum), then maximum restorability will not be achieved. On the other hand, if the value of T is chosen to be large (greater than the minimum), then there will be unnecessary routing tables created.

Some results that were obtained from this integer programming problem are discussed in the following section.

Restorable Spanning Tree Algorithm Heuristic

With the size of the integer programming problem increasing exponentially with respect to the number of nodes, the computation time needed to compute the optimal solution also increases exponentially. Although our approach is designed to minimize real time computation, faster computation is always preferred. It is for this reason that a heuristic algorithm is proposed as an alternative to compute the spanning trees. This section will discuss the Restorable Spanning Tre Al-gorithm (RSTA) heuristic with no implementation details.

The RSTA heuristic takes advantage of the fact that we are looking for multiple spanning trees. With this knowledge, it is possible to code an algorithm that can iteratively solve the problem, whereas the integer problem computes the spanning trees in parallel. From this iterative solution, the RSTA will compute the minimum number of routing tables, T, that are needed. This is more efficient than the integer program where the value of T is chosen without knowing whether it is minimal or not. To determine if the chosen T is minimal, the integer program must be solved multiple times with varying values of T until restoration is maximized.

At a high level, the algorithm first creates a spanning tree for the network. This spanning tree would restore all the edges that are not contained in it. Another way of saying this is that this spanning tree contains all the edges that still have to be restored. The objective now is to create an additional spanning tree that does not use any edges from the first spanning tree. If this is the case, then only two spanning trees are needed to restore the complete network from single edge failures. If it is not possible to find two disjoint spanning trees, then it is necessary to use edges from the first spanning tree to create the second one. This process continues until all edges are restored in the network. With each new spanning tree created, different edges from the first spanning tree are used. Eventually, the algorithm will converge either by restoring all the edges, or reaching a saturation level in which maximum restorability is reached in the network.

With the knowledge that a single spanning tree restores all edges that are not in the spanning tree, let graph Gᵢ=(Nᵢ, Eᵢ) represent a network for iteration i, where Nᵢ is the set of nodes in the network and Eᵢ be the set of remaining edges in the network. N₀ and E₀ are equal to the set N and E respectively. Each spanning tree that is calculated for iteration i, is stored in Mᵢ. Variable Rᵢ is the set of restored links with R₀={}. Variables SGⱼ and SMⱼ represent subnetworks and their corresponding spanning tree respectively. Finally, the variable T is the number of spanning trees that have been created.

The Restorable Spanning Tree Algorithm (RSTA) heuristic is as follows.

1. set i=0,T=0

2. M₀=spanning tree of G₀

3. T=T+1

4. E₁=E₀−M₀

5. R₁=E₀−M₀

6. Find M₁=spanning tree of G₁ if possible

7. if M₁ exists

(a) T=T+1

(b) R₂=R₁+(E₀−M₁)

(c) 2 disjoint spanning trees found, terminate

8. else the graph has been subdivided into smaller subgraphs

(a) For each subgraph SGⱼ, find it's spanning tree SMⱼ

(b) i=i+1,T=T+1

(c) Choose links from previous Mₖ, k<i spanning trees, such as to connect the subgraph SMⱼ to complete a spanning tree for Gᵢ. The links are chosen such that the number of times an edge is used in the spanning tree set are as low as possible.

(d) Eᵢ₊₁=Eᵢ−Mᵢ

(e) Rᵢ₊₁=Rᵢ+(E₀−Mᵢ)

(f) if (Rᵢ₊₁==E₀) then

i. all links are restored, terminate

(g) else if (Rᵢ₊₁==Rᵢ) then

i. Maximum restoration reached, terminate

(h) else revert back to G₁ and go to step 8(b)

After initialization, the algorithm starts by computing a spanning tree, M₀, of the graph G₀. Steps 4 and 5 update the edges that remain in the graph, E₁, and the currently restored edges, R₁. If a spanning tree can be created from G₁, then the algorithm will terminate because two disjoint spanning trees have been created, thereby restoring all links.

If a second spanning tree could not be created, then graph G₁ is not a connected graph. In other words, the graph has been divided into multiple subgraphs. Step 8(c) connects these subgraphs together using edges from previous spanning trees(Mₖ, k<i). The edges from the previous spanning trees are selected in a way as to minimize the number of times the edge is used in the spanning tree set. This can be easily done by associating a counter value with each of the edges in the graph. Steps 8(d) and 8(e) are used to update the edges and remaining edges of the graph. The next couple of steps of the algorithm cover the termination criterion. The first possible termination criterion is that all links are restored with the current number of spanning trees. This is accomplished in step 8(f) by testing the equivalence of the restoration set Rᵢ with the original set of edges E₀. The second possibility is that the network is not fully restorable, in which case Rᵢ is equivalent to Rᵢ₋ᵢ. Finally, if any of the termination criterion are not satisfied, the algorithm continues at step 8(a) with the remaining edges Eᵢ forming a new graph Gᵢ=(N, Eᵢ).

### DESCRIPTION OF A PREFERRED EMBODIMENT

This section discusses some of the results that were obtained through solving the integer programming problem for numerical examples and other experiments that were performed with respect to restoration. Integer Program Solution

The integer program was solved using an implicit enumeration al-gorithm package called“opbdp” [12]. This package was specifically designed for solving linear 0-1 optimization problems with integer co-efficients.

Spanning Tree Generator

The opbdp software package is a generalization of the Davis-Putnam enumeration method for linear pseudo-Boolean inequalities. This is essentially a logic-based implicit enumeration technique [11] [13].

The package was used as a means of solving the integer programming problem without looking into efficiency and speed of the computation, where efficiency refers to the speed and size of the problem itself. Further experiments would have to be done to improve the overall computation time while using this package as well as testing other software packages.

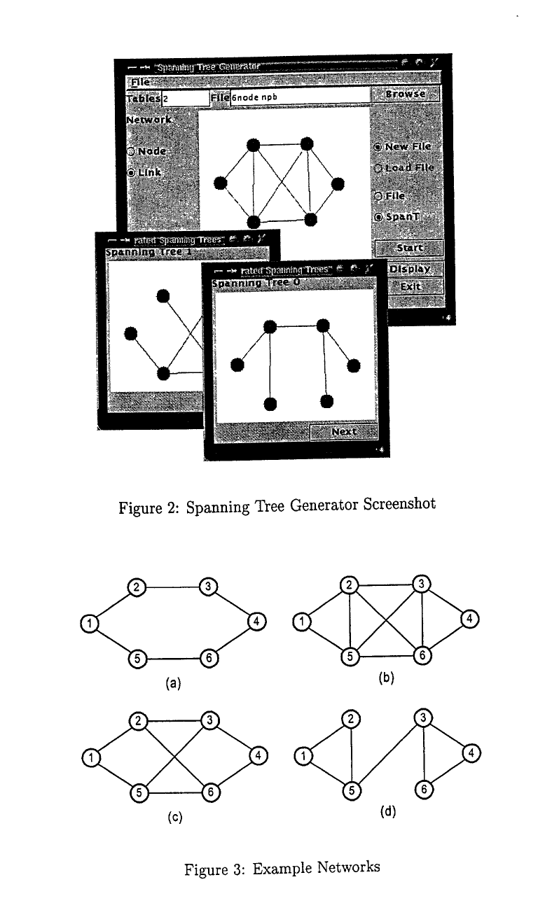

The opbdp package requires that all constraints to the optimization problem be written out explicitly, which is very time consuming with larger problems. The Spanning Tree Generator (STG) software is a front end to the opbdp package. A screenshot of STG is shown in FIG. 2 with two spanning trees generated.

STG is implemented in Java using the Java Software Developer's Kit 1.2.2 (SDK) running on a Linux Platform.

Computational Results

This section discusses some of the results that were obtained using STG and the opbdp package. The example network used was a six node network connected in various configurations to illustrate certain scenarios that may arise. These example networks are shown in FIG. 3.

FIG. 3(a) is configured in a ring topology which will require the number of spanning trees be equal to the number of links in the network. For this example, the value is six. Since |N|−1 links are required for a spanning tree, only one link can be restored for each spanning tree. This topology will require the most spanning trees for full restoration capability.

FIG. 3(b) is configured such that only two spanning were required for full restoration. To generalize, any fully connected network with the number of nodes greater than three will require only two spanning trees for full restoration. FIG. 3(b) is an optimal network topology requiring only 2×(N−1) arcs, which is exactly the minimum number of links needed for two spanning trees.

FIG. 3(c) will require more than two spanning trees for full restoration because it doesn't contain at least 2×(|N|−|) links. It is sufficient to say that if a network does not contain at least 2×(|N|−1) links, then more than two spanning trees are needed for full restorability. However, a network having 2×(|N|−1) or more links does not imply that only two spanning trees are needed for full restorability. In the case of FIG. 3(c), three spanning trees are needed for full restoration.

FIG. 3(d) illustrates the case where a network is not fully restorable. It's easily seen that link (3, 5) is needed for all spanning trees that are created for this network. In this case full restorability can not be reached, but maximum restorability is achieved with three spanning trees.

Table 1 gives a comparison between these network topologies. For a network with six nodes and 20 arcs(10 links), the optimal value for full restoration would be 20 (10 arcs per spanning tree). This is achieved with network (b). With a ring topology, network (a) required six spanning trees to reach full restoration with a minimum objective function value at 180. This suggests that network topology plays a significant role in restoration.

Although the integer programming problem was not formalized to account for double links failures, it does restore some double links failures. Consider, L to be the number of links in the network and N to be the number of nodes.

L−(N−1)=# of links restored by one spanning tree (16)

$$\begin{matrix}( \begin{matrix}L - ( N - 1 ) \\ 2\end{matrix} ) = \text{\# of double link failures recovered by one spanning tree} & ( 17 ) \\ ( \begin{matrix}L \\ 2\end{matrix} ) = \text{\# of possible double links failure} s & ( 18 ) \\ \frac{( \begin{matrix}L - ( N - 1 ) \\ 2\end{matrix} )}{( \begin{matrix}L \\ 2\end{matrix} )} = \text{\% of double link failures recovered by one spanning tree} & ( 19 ) \\ ( \begin{matrix}0 \\ 2\end{matrix} ) = 0 & ( 20 ) \\ ( \begin{matrix}1 \\ 2\end{matrix} ) = 0 & ( 21 )\end{matrix}$$

For multiple spanning trees, equation 19 can be generalized to

$$\begin{matrix}\frac{( \begin{matrix}L - ( N - 1 ) \\ 2\end{matrix} )}{( \begin{matrix}L \\ 2\end{matrix} )} + α = \begin{matrix}\% of double link failures \\ recovered by one spanning tree\end{matrix} & ( 22 ) \\ α = \frac{1}{( \begin{matrix}L \\ 2\end{matrix} )} {\sum }_{i = 2}^{T} {α}_{i} & ( 23 ) \\ {α}_{i} = ( \begin{matrix}N - 1 - β \\ 2\end{matrix} ) & ( 24 )\end{matrix}$$

where, αᵢ is the disjoint factor for spanning tree i, T is the number of spanning trees, and β is smallest number of links that this spanning tree has in common with any other spanning tree. The term a represents the disjoint factor for all spanning trees. Note that the summation in equation 23 is over i=2 to T, not i=1. From these equations, the percentage of double link failures that can be restored is calculated and shown in Table 1. The next section will propose some considerations for implementation.

Implementation

Issues pertaining to the implementation of the two-phase restoration system are discussed in this section. Multi-Protocol Label Switching [14] (MPLS) and Active Networking are proposed as potential technologies that can be used to implement the restoration system. Due to the young age of these technologies, there are a lot of outstanding issues concerning their own implementations. This chapter will not discuss implementation issues of MPLS or active networking, but will refer readers to other sources. The focus will be placed on how the two-phase restoration system, MPLS, active networking, and OSPF will function as a whole to provide fast restoration.

Implementation Issues with OSPF

This section will detail some of the interoperational issues of MPLS or active networks with OSPF. One of the main benefits of the two-phase restoration system is that it does not affect the operation of OSPF. There are five main issues when implementing the two phase restoration system. The first is distributing the restoration table information followed by the detection of a fault. This is followed by propagating network failure information to the necessary nodes in the network. Fourth is the actual operation of either MPLS or active networking to provide for fast restoration (primary scheme). After the primary scheme of the two-phase restoration system is complete, control of the network must be passed back to OSPF for optimal restoration(secondary scheme).

Before tackling each one of those issues, there needs to be an understanding of the scope or restoration provided. An OSPF network is divided up into different subnetworks called areas. It is in these areas that the two-phase restoration system will reside. For each area in an OSPF network, a separate two-phase restoration system would be implemented thereby reducing the size of the preconfigured restoration tables to the size of an area. This leads to the conclusion that the MPLS and active network domain are the same as an OSPF area.

Issue 1: Distribution

After calculating the set of restoration tables, it is necessary that all nodes within the area are aware and have the same set of tables. A proposed method for distributing this information throughout the network is described here.

MPLS Label Distribution

With the already reliable flooding mechanism in place by OSPF, distribution of labels would be most efficient using piggybacking. After the preconfigured restoration tables are created and the corresponding labels have been assigned, the labels can be piggybacked on top of OSPF's Hello packets or any other Link State Advertisement (LSA). According to RFC 2328 [20], five out of the eight option bits in the LSA options field have meaning. One of these options could be used to indicate that the LSA is carrying MPLS label information. An alternative to this is since OSPF runs over top of IP (Internet Protocol), an option bit can be used in the IP header to indicate MPLS label distribution. Label distribution is only relevant where the preconfigured restoration tables are calculated by only one node in the area. Distributing MPLS labels is not even an issue if the restoration tables are calculated by each node in the area. As a link state routing protocol, each of the nodes in an area have knowledge of the topology of that area. With that knowledge, the restoration tables can be created by each node individually. This concept is very much the same as used by OSPF when performing spf calculations.

Active Networks Preconfigured Routing Table Distribution

As described previously, calculation of the preconfigured restoration tables can be done by one node and flooded to all the other nodes or it can be calculated by all nodes. With all nodes executing the same calculations for obtaining the restoration tables, there is no need for distribution. However, the alternative is to have a single node perform the calculation and then distribute the restoration tables to the other nodes. The same method of piggybacking can be applied here as was done in MPLS label distribution. An alternative to piggybacking is to encapsulate these routing tables into active packets called Restoration Table Advertisement (RTA) active packets. RTA packets can be assigned their own Type ID in the ANEP header. The Type ID would be associated with an active application that would handle the processing of the restoration tables in the RTA packet. The RTA Active Application (RTA3) would handle the responsibility of storing the RTA payload in a persistent state for later use. Since RTA3 needs access to resources, possibly the filesystem, certain security measures must be in place [19]. Security measures such as access policies to resources and authentication of RTA packets must be addressed. These security measures would most likely reside in the execution environment that the RTA3 would execute in.

Issue 2: Fault Detection

Restoration systems at the Physical Layer respond to the loss of physical transmission media, however, faults in IP networks are not necessarily as catastrophic. Congestion, software failures, and equipment configuration are some examples of non-catastrophic faults. For these types of faults, short time restoration and reconfiguration may be needed.

Fault detection is a major component of the restoration scheme. Having the ability to detect and verify the validity of a fault will greatly impact the restoration time. In OSPF, the OSPF Hello protocol is given the responsibility of detecting and verifying faults within the network. The Hello protocol broadcasts Hello packets every HelloInterval on each interface of a node. If a node does not receive a Hello packet from one of its neighbours within a timeout period called the RouterDeadInterval, the node assumes that its neighbour is now dead or a fault has occurred between the two. Typically, the RouterDeadInterval time is configured to be four times the value of the HelloInterval time. The reason for this is to verify that a fault is valid so that OSPF will not perform any unnecessary calculations. Determining the validity of a fault is necessary, but with a HelloInterval of 10 seconds, there will be a period of 40 seconds where communication is lost. With ever increasing transmission speeds, the amount of data lost within this time could be extremely high. A better approach is needed to detect faults within the network.

One approach is to detect the loss of carrier or loss of connection between two neighbours. Communication with lower level protocols will provide this detection ability which OSPF already supports. The OSPF Logical Link Down (LLDown) flag is set when indication from lower-level protocols determine that the neighbour connected to this interface is unreachable. With the use of this flag, immediate action can be taken when a loss of carrier occurs.

Another approach is to start recovery procedures after the first missed Hello packet. This method could be used for faults that are not as severe as a loss of carrier. However, recovery after one missed Hello packet could result in unnecessary routing calculations if the failure that caused the missed Hello packet is short lived. This is one of the reasons why OSPF requires that no Hello packets are to be received for the RouterDeadInterval before declaring a fault.

Both approaches have one common issue that needs to be addressed. The issue is that there may be a possibility that the occurring fault is very short. In both methods, shortest path first (spf) calculations would have taken place immediately after the LLDown flag was set or a missed Hello packet. When the temporary fault is resolved, another spf calculation would take place to return OSPF to its original state before the fault occurrence. One of the most common occurrences of a temporary fault would be an accidentally disconnected cable. OSPF has two parameters that can be configured to help with unnecessary spf calculations.

Issue 3: Fault Notification

In order for the primary scheme of the two-phase restoration system to be of any use, the nodes in the network must know about an occurrence of a fault.

MPLS

Fault notification throughout the area is necessary for MPLS. With ingress and egress nodes responsible for assigning and removing MPLS labels respectively, flooding is not necessary, but is acceptable. A more efficient alternative to flooding is to have the ingress and egress nodes participate in a Multicast group. Multicasting is a way of distributing data to multiple recipients. Where flooding is broadcasting, multicasting is a broadcast to only recipients that are associated with a certain multicast group. More information can be found on multicasting in

[21] [22]. Multicasting in OSPF is defined as an extension in RFC 1584 [23]. Multicast OSPF (MOSPF) can be used as the transport for fault propagation in the MPLS domain.

Active Networks

Active network nodes respond when active packets are received from other nodes. This is very similar to MPLS, where MPLS enabled nodes would respond to the attached MPLS labels. A difference between the two is that ingress and egress nodes in MPLS assign and remove labels, whereas in active networks, potentially any active node can encapsulate and send active packets. The question is which node initiates the encapsulation. Drawing from MPLS, ingress nodes can perform this initial encapsulation. Once the initial encapsulation is performed, active nodes within the area would do the routing of the active packet. This suggests that only ingress active nodes need knowledge of a fault since interior nodes respond to the initial active packet. However, egress nodes also need to know about the fault so that the outgoing packet (destined for another area) is no longer encapsulated. The same procedures for multicasting the fault to the ingress and egress nodes with MOSPF can be used here.

Issue 4: Primary Scheme

After receiving a fault notification, ingress nodes would either attach MPLS labels or encapsulate packets for active network use. Actual operation of MPLS or active networking was briefly described previously and is left to the reader for further investigation. At this point, data would be rerouted using the preconfigured restoration tables through the network. The primary scheme is now dependent on MPLS and active networking technology to provide reliable data transfer through the area.

During the operation of the primary scheme, OSPF is running in the background. It is still sending Hello packets, and other LSAs to its neighbours. The only difference is that all of these packets are now being routed by the primary scheme technologies and not OSPF itself. To the knowledge of OSPF, the network is has not changed because it does not know about the network failure. When OSPF realizes that a failure exists (the RouterDeadInterval time has elapsed), it will begin procedures for optimal restoration as described in the following section. However, consider the case of a short lived network failure.

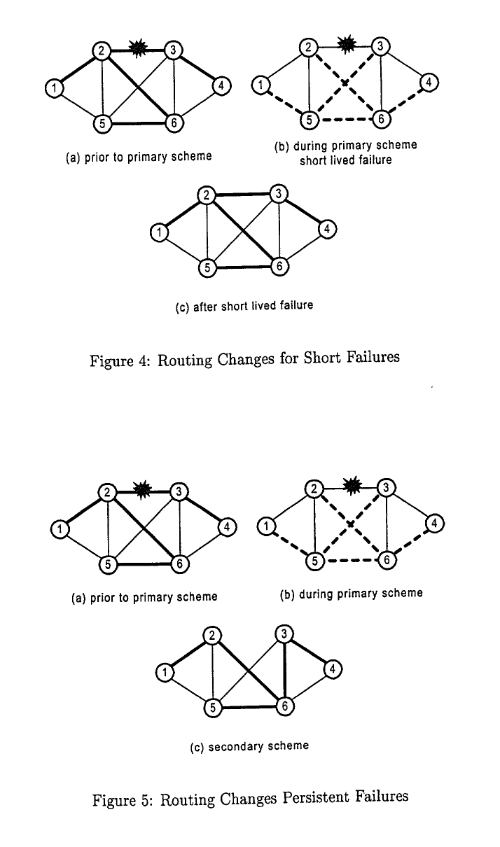

A short lived network failure could exist due to a configuration error in the node. Realizing that an error in the configuration exists, the administrator corrects the error within the RouterDeadInterval time. This would cause the primary scheme to be activated (configuration error) and then hopefully deactivated when the configuration error is corrected so that OSPF can resume control. Similar to propagating a fault notification, when a short lived fault is corrected, a resume notification is issued to the ingress and egress nodes by the same node that detected the fault. A fault is considered corrected when the node that issued the fault notification hears a Hello packet across the failed link. The resume notification would cause the primary scheme to be deactivated. This would disable MPLS(do not attach labels) or active networking(do not encapsulate) so that routing of data is resumed by OSPF. These routing changes for a short lived failure are depicted in FIG. 4.

Issue 5: Secondary Scheme

For a fault which is recognized by OSPF, OSPF would perform an spf calculation to reconfigure its routing tables optimally. At this point, the primary scheme should hand over control to the secondary scheme. The handover is merely deactivating the the primary scheme. Since OSPF recognizes a fault after the RouterDeadInterval time, the node which issued the fault notification would also listen on the failed interface for the same amount of time. If no Hello packet is seen, then the node would issue a resume notification to the ingress and egress nodes to terminate the primary scheme. The routing changes for a persistent failure is shown in FIG. 5.

An issue arises here with respect to convergence. What happens if the primary scheme is deactivated and data is sent before OSPF converges to the optimal state? A simple solution to this problem is to wait until OSPF has converged before multicasting the resume notification.

Other Issues

This section will briefly describe some other issues concerning the operation and implementation of the two-phase restoration system.

1. Area Border Routers(ABRs): An ABR is a router which is at the boundary of an OSPF area. In this case, ABRs are required to have two sets of preconfigured restoration tables, one for each area it is connected to. If there is ever an occasion where a fault occurs in the interior of each area connected to the ABR, more computation is necessary for proper data transmission.

With the ABR having knowledge of two failures, (one in each connected area), it must first remove the attached label and swap it with a label from the other restoration table. This is of course for when MPLS is being used. When active networking is used, the ABR would have to execute the active application twice. The first time would be to decapsulate the active packet after receiving it from the first area. The second active application would be executed to encapsulate the packet for the next area. This dual processing of the packet can be avoided by putting more complexity into the active application of the ABRs. The ABR active application would be able to receive the packet from one area and directly encapsulate it for transmission into the next area.

2. Fault Localization: Another interesting issue comes in the area of fault localization. The ability to localize a fault has many advantages. The first is that the amount of traffic generated by a fault notification is reduced to only those local to a fault. The terms local to a fault refer to the minimum number of nodes that are needed for there to be a restoration path around the fault. Another benefit to fault localization is that the optimal path is still being used where ever possible in the network.

In MPLS fault localization would require a few changes. The first change is that all MPLS enabled nodes be able to attach labels to any data that arrives for the purpose of restoration. In this way, the fault need not be propagated to the ingress and egress nodes, but just to those nodes local to the fault. An alternative to this would be to deploy explicit routing using loose source routing. Loose source routing is where only a portion of the entire path is specified. The portion that would be specified is the path around the fault. This leaves the remainder of the path to follow the shortest path provided by OSPF.

Active networking can deploy fault localization in a very similar manner. Only active nodes local to the fault would encapsulate and transfer data in the form of active packets.

The difficult part here is determining which nodes are local to the fault. One solution is to select the two nodes that are adjacent to the fault. If there is a common node distance one away from the two fault adjacent nodes, then these three nodes are local to the fault. If a common node does not exist, then all nodes with a distance of one from the two adjacent nodes are examined. From this set of nodes and all associated links between them, a spanning tree is formed. If a spanning tree exists, then this set of nodes is local. If a spanning tree is not found, then the search is expanded to all nodes with a distance of two from the adjacent nodes. Eventually, the edges of the area would be reached, and the fault is no longer local.

If it is not already clear, real time processing is necessary for fault localization.

Additional Comments

We conclude this document by identifying some of the important issues to be addressed as an extension to this research.

1. Reducing the size of the IP problem: With an increase in the number of nodes leading to an exponential increase in the number of decision variables, it is apparent that reducing the size of the IP problem is necessary. The most obvious reduction is formulating the problem in terms of links, not arcs as defined. This would reduce the number of decision variables by half. The associated problem with using links is that the connectivity constraint would have to be reformulated in a fashion to account for the od pairs traversing the links in opposite directions. Using links would also remove the necessity for Constraint 9.

2. Speed-up: Additional work is required to improve the computation time of the IP problem. This can possibly involve reducing the size of the problem as mentioned previously. Another possible approach is to obtain an initial feasible solution to the problem so that less nodes will have to be examined during the optimization procedure. The RSTA heuristic can be fully tested and investigated further to provide faster computation time.

3. Network topology: As was stated from the results, network topology greatly affects the number of spanning trees that are required. Designing networks with enough redundancy to require only two spanning trees for restoration is desired. In discussing network topology, the IP problem assumed a symmetric network, but this is not always the case. Further research into asymmetric networks would be needed to develop a more general optimization model, where a symmetric network would be a special case of this general model.

4. Dual link failures: Although single link failures are most common, there are situations where dual link failures may exist. Although the IP problem was not formulated to protect dual links failures, it inherently does. The optimization model can be altered slightly to provide for even better dual link failure protection. Altering the formulation for this provision will increase the number of decision variables by the number of dual link permutations that are possible in the network. In the same manner that the formulation constraints checked for single link protection, they can check for dual link protection. The original model examined whether or not a link existed in a spanning tree. The new model would then examine whether or not all possible combinations of dual links existed in a spanning tree. It is apparent that the new model would also account for all single links failures as well.

5. Fault detection: Fault detection always remains an important issue in restoration. With the two-phase restoration system, the validity of a fault is not as big a concern as it is in OSPF. This is because the two-phase restoration system does not affect the original routing table in the primary scheme, thereby eliminating any unnecessary spf calculations. Even so, it is still important to be able to detect faults as quickly as possible so that restoration systems in place can take action. This document looked only at single link faults, but node faults would be a very important event to consider in the future.

6. Adaptive algorithm: Currently, after a network failure, the set of preconfigured restoration tables would have to be recalculated for the new network topology. This can be greatly reduced by looking into algorithms that can update spanning trees when individual links are subject to change [24]. Research is needed in updating a set of spanning trees while still preserving the maximum restoration possible.

Conclusion

The contributions of this work are in the field of survivable networks or network restoration. With focus on the network or IP layer, this thesis distinguishes itself from other papers whose main target is Physical Layer restoration. This work has provided a view of current restoration techniques at both the network and Physical Layer. A two phase restoration system has been introduced to provide fast restoration. We have identified the issue of balancing the restoration tables across the network by developing an optimization model and the solution for the problem. A heuristic has also been proposed to obtain near optimal solutions to the problem. Finally, the necessary background research for implementation of the two-phase restoration system has been presented.

The first contribution is the introduction of the two-phase restoration system to enhance the current OSPF restoration mechanism. The OSPF restoration mechanism worked very well to provide optimal path reconfiguration but at the expense of speed. Fast restoration is provided by preconfiguring a set of restoration tables that can be used immediately upon failure. The combination of the preconfigured restoration tables, and OSPF's optimal path reconfiguration leads to the two-phase restoration system that meets two important requirements. These requirements are fast restoration and optimal reconfiguration.

Another contribution is the optimization model that has been developed for the primary scheme of the two-phase restoration system. Not only does the primary scheme provide for fast restoration, but it provides it in an optimal manner in two ways. With a specified number of restoration tables, the optimization model will maximize restoration of the number of links that are protected. If full restoration is desired, the optimization model will determine the necessary configurations of the restoration tables to provide the minimum set of tables required. The problem is formulated as a non-linear integer programming (IP) problem with linear constraints. Testing has shown that the IP problem converges to an optimal state. To help ease the design process of the problem, a Spanning Tree Generator (STG) tool was created. STG aids in translating a network diagram into a set of equations that formatted correctly for the opbdp package.

A heuristic algorithm has been proposed for a near optimal solution to the primary scheme. The Restorable Spanning Tree Algorithm (RSTA) can provide for faster computation time and easier implementation. A case study of the RSTA heuristic was also presented to illustrate possible scenarios that may arise during computation.

Lastly, research has been done in dealing with the implementation of the two-phase restoration system. The interaction between MPLS, active networking and OSPF plays an important role in the overall system. This architecture is the first step in implementing the two-phase restoration system. This document has provided some of the background research necessary for implementing the two-phase restoration system.

TABLE 1
Comparison between different network topologies

| | | | Single Link | Double Link |
|---|---|---|---|---|
| Network | Minimum | Trees | Restoration | Restoration |
| a | 180 | 6 | 100% | 0% |
| b | 20 | 2 | 100% | 44.4% |
| c | 58 | 3 | 100% | 32.1% |
| d | 66 | 3 | 85.7(max) % | 14.3% |

1. A method of restoring an IP network in the event of a communication failure between two routers comprising:
providing an IP network comprising:
a plurality of routers;
a plurality of links between the routers for communication of data between each router and any other one of the routers, the links being arranged to provide between each router and each of the other routers at least two alternative paths;
the network being arranged such that each router is provided with a respective primary routing table by which there is provided for that router a respective one of a plurality of preferred paths selected from the alternative paths from that router to each of the other routers;
communicating the data between the routers using for routing the data the primary routing tables;
before a communication failure occurs, pre-calculating for the network a plurality of spanning trees arranged to provide alternative paths in the event that communication between two routers is determined to have failed;
for each of the calculated spanning trees, providing for each the routers a respective one of a plurality of restoration routing tables and storing in a memory associated with each router the plurality of restoration routing tables for that router in preparation for a communication failure;
detecting a fault indicative of a communication failure;
depending upon the two routers between which the communication is determined to have failed, selecting one of the spanning trees and the restoration routing tables associated with that spanning tree;
communicating to the routers an instruction to transfer routing from the primary routing table to the selected one of the pre-calculated restoration routing tables stored in the memory of the router;
and communicating the data between the routers using the selected, pre-calculated, stored restoration routing tables.

2. The method according to claim 1 wherein routing is transferred to the restoration tables substantially without delay.

3. The method according to claim 1 wherein there are two spanning trees and for each router two restoration tables.

4. The method according to claim 1 wherein there are three spanning trees and for each router three restoration tables.

5. The method according to claim 1 wherein the spanning trees are pre-calculated to minimize number of spanning trees necessary to restore all paths.

6. The method according to claim 1 wherein the spanning trees are pre-calculated by the algorithm specified in the specification.

7. The method according to claim 1 wherein, when a communication failure is detected by a router, that detection of a communication failure causes a communication to all other routers to use the restoration table.

8. The method according to claim 1 wherein, when a communication failure is detected by a router, that detection of a communication failure causes a communication only to edge routers and wherein the edge routers are arranged to modify the communicated data to communicate the requirement to use the restoration tables to internal routers.

9. The method according to claim 1 wherein the communicated data is modified by adding a tag.

10. The method according to claim 1 wherein the communicated data is modified by changing the information contained in the ANEP header.

11. The method according to claim 1 wherein the restoration tables form a first fault response system and there is provided a secondary fault response system in which, after a pre-determined delay after detection of a fault without the communication being restored, the primary router tables are recalculated taking into account the absence of the failed communication and the routers arranged to transfer routing back to the re-calculated primary routing tables.

12. The method according to claim 11 wherein primary routing table is re-calculated to provide optimum paths.

13. The method according to claim 11 wherein primary routing tables are re-calculated by the routers.

14. The method according to claim 1 wherein the fault detection is generated in response to a detection in the physical layer so as to be substantially without delay.
